(19) United States
(12) Patent Application Publication
(10) Pub. No.: US 2014/0313952 A1
(43) Pub. Date: Oct. 23, 2014

(54) METHOD, APPARATUS, AND COMPUTER PROGRAM PRODUCT FOR ASSIGNED ACCESS SLOT GROUP INDICATION

(71) Applicant: NOKIA CORPORATION, Espoo (FI)

(72) Inventor: Chittabrata Ghosh, Fremont, CA (US)

(21) Appl. No.: 13/865,954

(22) Filed: Apr. 18, 2013

(51) Int. Cl. H04W 72/04; H04W 52/02

(52) U.S. Cl. CPC H04W 72/042; H04W 52/0216
USPC 370/311; 370/329

(57) ABSTRACT

Method, apparatus, and computer program product embodiments of the invention are disclosed for assigned access slot group indication employable, for example, in connection with wireless networks. In an example embodiment of the invention, a method, comprises: receiving at a device from an access node: an encode of a block portion of a start association identifier and an encode of a block portion of an end association identifier; and a first indication and a second indication; calculating, at the device, a middle of the segment; decoding, at the device in view of said first indication, the encode of the block portion of the start association identifier based at least partly on said middle of the segment; and decoding, at the device in view of said second indication, the encode of the block portion of the end association identifier based at least partly on said middle of the segment.

### FIELD

The field of the invention relates to assigned access slot group indication employable, for example, in connection with wireless networks.

### BACKGROUND

Modern society has adopted, and is becoming reliant upon, wireless communication devices for various purposes, such as connecting users of the wireless communication devices with other users. Wireless communication devices can vary from battery powered handheld devices to stationary household and/or commercial devices utilizing an electrical network as a power source. Due to rapid development of the wireless communication devices, a number of areas capable of enabling entirely new types of communication applications have emerged.

Cellular networks facilitate communication over large geographic areas. These network technologies have commonly been divided by generations, starting in the late 1970s to early 1980s with first generation (1G) analog cellular telephones that provided baseline voice communications, to modern digital cellular telephones. GSM is an example of a widely employed 2G digital cellular network communicating in the 900 MHZ/1.8 GHZ bands in Europe and at 850 MHz and 1.9 GHZ in the United States. While long-range communication networks, like GSM, are a well-accepted means for transmitting and receiving data, due to cost, traffic and legislative concerns, these networks may not be appropriate for all data applications.

Short-range communication technologies provide communication solutions that avoid some of the problems seen in large cellular networks. Bluetooth is an example of a short-range wireless technology quickly gaining acceptance in the marketplace. In addition to Bluetooth other popular short-range communication technologies include Bluetooth Low Energy, IEEE 802.11 wireless local area network (WLAN), Wireless USB (WUSB), Ultra Wide-band (UWB), ZigBee (IEEE 802.15.4, IEEE 802.15.4a), and ultra-high frequency radio frequency identification (UHF RFID) technologies. All of these wireless communication technologies have features and advantages that make them appropriate for various applications.

### SUMMARY

Method, apparatus, and computer program product embodiments of the invention are disclosed for assigned access slot group indication employable, for example, in connection with wireless networks.

In an example embodiment of the invention, a method, comprises:

receiving at a device from an access node via an information element:
an encode of a block portion of a start association identifier and an encode of a block portion of an end association identifier, wherein said association identifiers correspond to a segment; and
a first indication and a second indication;

calculating, at the device, a middle of the segment, wherein said calculation takes into account an end of the segment and a start of the segment;

decoding, at the device in view of said first indication, the encode of the block portion of the start association identifier based at least partly on said middle of the segment; and

decoding, at the device in view of said second indication, the encode of the block portion of the end association identifier based at least partly on said middle of the segment.

In an example embodiment of the invention, the method further comprises:

receiving at the device from the access node via the information element an encode of a sub-block portion of the start association identifier and an encode of a sub-block portion of the end association identifier; and

decoding, at the device in view of a reference value and an offset value, the encode of the sub-block portion of the start association identifier and the encode of the sub-block portion of the end association identifier, wherein said offset value provides access node data buffering information with respect to sub-block.

In an example embodiment of the invention, the method further comprises:

receiving at the device from the access node via the information element an encode of an address location portion of the start association identifier and an encode of an address location portion of the end association identifier; and

decoding, at the device in view of a reference value and an offset value, the encode of the address location portion of the start association identifier and the encode of the address location portion of the end association identifier, wherein said offset value provides access node data buffering information with respect to sub-block.

In an example embodiment of the invention, the method further comprises wherein one or more of:

said start association identifier and said end association identifier correspond to a restricted access window; and

said information element is a restricted access window parameter set information element.

In an example embodiment of the invention, the method further comprises:

receiving, at the device from the access node via a second information element, said offset value.

In an example embodiment of the invention, the method further comprises wherein the second information element is a segment count information element.

In an example embodiment of the invention, the method further comprises wherein said segment is a page segment served by a traffic indication map segment.

In an example embodiment of the invention, the method further comprises wherein the block portion of the start association identifier and the block portion of the end association identifier are with respect to a page.

In an example embodiment of the invention, the method further comprises:

receiving, at the device from the access node, indication of a target wake time group, wherein said target wake time group expresses periodic restricted access window group membership.

In an example embodiment of the invention, an apparatus comprises:

at least one processor; and

at least one memory including computer program code, the at least one memory and the computer program code configured to, with the at least one processor, cause the apparatus at least to perform:

receive at the apparatus from an access node via an information element:
an encode of a block portion of a start association identifier and an encode of a block portion of an end association identifier, wherein said association identifiers correspond to a segment; and
a first indication and a second indication;

calculate, at the apparatus, a middle of the segment, wherein said calculation takes into account an end of the segment and a start of the segment;

decode at the apparatus in view of said first indication, the encode of the block portion of the start association identifier based at least partly on said middle of the segment; and

decode, at the apparatus in view of said second indication, the encode of the block portion of the end association identifier based at least partly on said middle of the segment.

In an example embodiment of the invention, the apparatus further comprises wherein the at least one memory and the computer program code are further configured to, with the at least one processor, cause the apparatus to:

receive at the apparatus from the access node via the information element an encode of a sub-block portion of the start association identifier and an encode of a sub-block portion of the end association identifier; and

decode, at the apparatus in view of a reference value and an offset value, the encode of the sub-block portion of the start association identifier and the encode of the sub-block portion of the end association identifier, wherein said offset value provides access node data buffering information with respect to sub-block.

In an example embodiment of the invention, the apparatus further comprises wherein the at least one memory and the computer program code are further configured to, with the at least one processor, cause the apparatus to:

receive at the apparatus from the access node via the information element an encode of an address location portion of the start association identifier and an encode of an address location portion of the end association identifier; and

decode, at the apparatus in view of a reference value and an offset value, the encode of the address location portion of the start association identifier and the encode of the address location portion of the end association identifier, wherein said offset value provides access node data buffering information with respect to sub-block.

In an example embodiment of the invention, the apparatus further comprises wherein one or more of:

said start association identifier and said end association identifier correspond to a restricted access window; and

said information element is a restricted access window parameter set information element.

In an example embodiment of the invention, the apparatus further comprises wherein the at least one memory and the computer program code are further configured to, with the at least one processor, cause the apparatus to:

receive, at the apparatus from the access node via a second information element, said offset value.

In an example embodiment of the invention, the apparatus further comprises wherein the second information element is a segment count information element.

In an example embodiment of the invention, the apparatus further comprises wherein said segment is a page segment served by a traffic indication map segment.

In an example embodiment of the invention, the apparatus further comprises wherein the block portion of the start association identifier and the block portion of the end association identifier are with respect to a page.

In an example embodiment of the invention, the apparatus further comprises wherein the at least one memory and the computer program code are further configured to, with the at least one processor, cause the apparatus to:

receive, at the apparatus from the access node, indication of a target wake time group, wherein said target wake time group expresses periodic restricted access window group membership.

In an example embodiment of the invention, a computer program product comprises computer executable program code recorded on a non-transitory computer readable storage medium, the computer executable program code comprising:

code for causing receipt at a device from an access node via an information element of:
an encode of a block portion of a start association identifier and an encode of a block portion of an end association identifier, wherein said association identifiers correspond to a segment; and
a first indication and a second indication;

code for causing calculation, at the device, of a middle of the segment, wherein said calculation takes into account an end of the segment and a start of the segment;

code for causing decode, at the device in view of said first indication, of the encode of the block portion of the start association identifier based at least partly on said middle of the segment; and

code for causing decode, at the device in view of said second indication, of the encode of the block portion of the end association identifier based at least partly on said middle of the segment.

In an example embodiment of the invention, an apparatus comprises:

means for receiving from an access node via an information element:
an encode of a block portion of a start association identifier and an encode of a block portion of an end association identifier, wherein said association identifiers correspond to a segment; and
a first indication and a second indication;

means for calculating a middle of the segment, wherein said calculation takes into account an end of the segment and a start of the segment;

means for decoding, in view of said first indication, the encode of the block portion of the start association identifier based at least partly on said middle of the segment; and

means for decoding, in view of said second indication, the encode of the block portion of the end association identifier based at least partly on said middle of the segment.

In this manner, embodiments of the invention provide assigned access slot group indication functionality employable, for example, in connection with wireless networks.

### DESCRIPTION OF THE FIGURES

FIG. 1 discloses a deployment scenario for assigned access slot group indication functionality in accordance with at least one example embodiment of the present invention.

FIG. 2 discloses an example restricted access window parameter set (RPS) information element (IE) in accordance with at least one example embodiment of the present invention.

FIG. 3 discloses an example segment count IE in accordance with at least one example embodiment of the present invention.

FIG. 4 discloses a computer in accordance with at least one example embodiment of the present invention.

FIG. 5A discloses a functional block diagram in accordance with at least one example embodiment of the present invention.

FIG. 5B discloses a flow diagram in accordance with at least one example embodiment of the present invention.

FIG. 6 discloses a further computer in accordance with at least one example embodiment of the present invention.

### DISCUSSION OF EXAMPLE EMBODIMENTS OF THE INVENTION

### Assigned Access Slot Group Indication—General Functionality

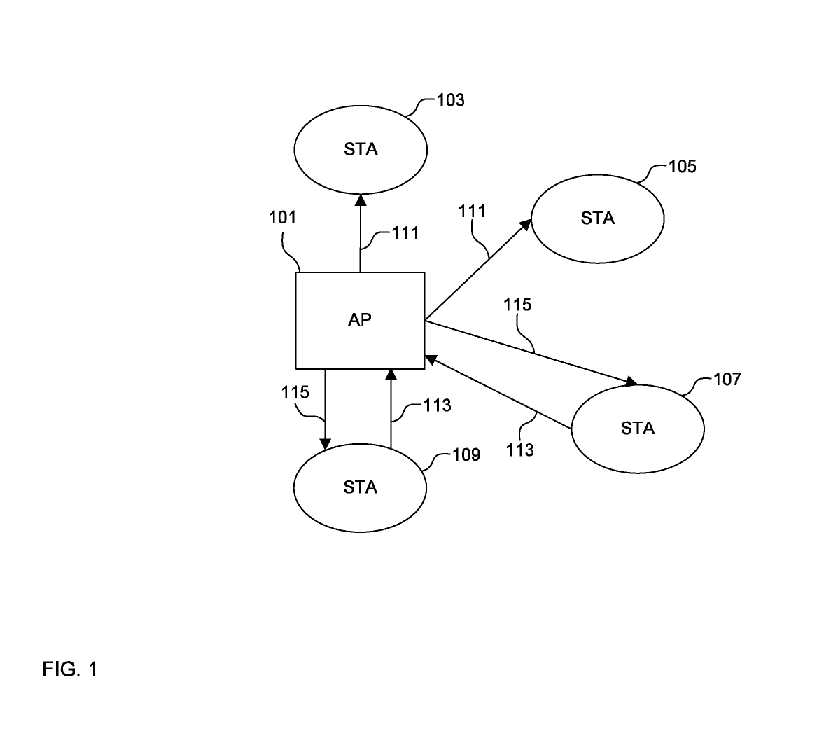

General assigned access slot group indication according to at least one example embodiment will now be discussed. As an illustrative example of such functionality, shown in FIG. 1 is a deployment scenario, according to at least one example embodiment, for the assigned access slot group indication functionality now discussed. Shown in FIG. 1 are access point AP 101, traffic indication map (TIM) STAs 103 and 105, and non-TIM STAs 107 and 109. The Institute of Electrical and Electronics Engineers 802.11ah task group is specifying a network to which at least some embodiments discussed herein may be applied. STAs discussed herein may have corresponding STA identifiers (e.g., association identifiers (AIDs). The STA identifiers (e.g., AIDs) may be the subject of an addressing hierarchy. The addressing may comprise one or more pages. Each page may comprise one or more blocks. Each block may comprise one or more sub-blocks (SBs). Each SB may comprise one or more address locations (e.g., AID address locations), with each such address location perhaps corresponding to the identifier of a STA.

As one non-limiting example hierarchy may be four pages (e.g., corresponding to a 2 bit page index of a 13-bit AID), 32 blocks within each page (e.g., corresponding to a 5 bit block offset and/or block index of a 13-bit AID), eight SBs within each block (e.g., corresponding to a 3 bit SB index of a 13-bit AID), and eight AID address locations (e.g., corresponding to a 3 bit SB bitmap and/or STA bit position index bits of a 13-bit AID) in each SB, with each such AID address location corresponding to the AID of a STA. As a second non-limiting example the address hierarchy may be eight pages (e.g., corresponding to a 3 bit page index of a 13-bit AID), 64 blocks within each page (e.g., corresponding to a 6 bit block offset and/or block index of a 13-bit AID), four SBs within each block (e.g., corresponding to a 2 bit SB index of a 13-bit AID), and four AID address locations (e.g., corresponding to a 2 bit SB bitmap and/or STA bit position index bits of a 13-bit AID) in each SB, with each such AID address location corresponding to the AID of a STA. As a third non-limiting example the address hierarchy may be sixteen pages (e.g., corresponding to a 4 bit page index of a 13-bit AID), 128 blocks within each page (e.g., corresponding to a 7 bit block offset and/or block index of a 13-bit AID), two SBs within each block (e.g., corresponding to a 1 bit SB index of a 13-bit AID), and two AID address locations (e.g., corresponding to a 1 bit SB bitmap and/or STA bit position index bits of a 13-bit AID) in each SB, with each such AID address location corresponding to the AID of a STA. In at least one embodiment, there may be more or fewer hierarchy levels in AID addressing.

Further according to the illustrative example, as discussed in greater detail herein, via such functionality an AP may dispatch to a STA (e.g., a TIM or a non-TIM STA) indication of assignment to an assigned access slot group. As a non-limiting example, the assignment to an assigned access slot group may be assignment to a restricted access window (RAW) group or to a periodic restricted access window (PRAW) group. A STA (e.g., a TIM STA) so assigned to such a RAW group may perform medium access during the corresponding RAW. As a non-limiting example, implementation may be such that the STA performs contention in order or secure medium access during the RAW, or implementation may be such that the STA need not perform contention in order to secure medium success during the RAW. A STA (e.g., a non-TIM STA) so assigned to such a PRAW group may awaken at its wakeup time (e.g., a wakeup time received during association) and perform, medium access during the corresponding PRAW. As non-limiting examples, implementation may be such that the STA performs contention in order to secure medium access during the PRAW, or implementation may be such that the STA need not perform contention in order to secure medium access during the PRAW. Such non-TIM STAs may not need to listen to beacons and, thereby, may potentially experience power saving. Moreover, optionally implementation may be such that medium access within times other than RAWs and/or PRAWs may be according to legacy IEEE 802.11 contention. Where thirteen bit AIDs—having two bits conveying page and eleven bits conveying block, sub-block (SB), and AID address location for that page—are employed a RAW group start AID may be conveyed, with respect to a page, via seven bits and/or a RAW end AID may be conveyed, with respect to a page, via seven bits. As another non-limiting example, where such thirteen bit AIDs are employed a PRAW group start AID and/or a PRAW group end AID may be conveyed, with respect to a page, via twenty-two bits.

Further according to the illustrative example, AP 101 may buffer downlink data for STAs 103-109. TIM STAs 103 and 105 may come to learn that such buffered downlink data awaits them by decoding beacons 111 (e.g., long and short beacons) which may be dispatched by AP 101. Non-TIM STAs 107 and 109, which as a non-limiting example may be power constrained, do not decode such beacons. By not decoding beacons non-TIM STAs 107 and 109 may garner a number of potential benefits including power saving. As a non-limiting example, one or more of STAs 103-109 may be sensors.

Still further according to the illustrative example, non-TIM STAs 107 and 109 each may awaken (e.g., exit a power save mode) at its corresponding target wake time (TWT) and, as appropriate, may perform either or both of dispatching (113) to AP 101 uplink traffic which it may have buffered while asleep (e.g., while in a power save mode) and retrieving (115) downlink data from AP 101 which AP 101 may have buffered while the corresponding non-TIM STA was asleep (e.g., in a power save mode). Optionally, a STA may confirm the absence of traffic (e.g., via carrier sense multiple access (CSMA)) prior to uplink and/or downlink of buffered data at its TWT. In the case where a STA of non-TIM STAs 107 and 109 when awakening both dispatches to AP 101 buffered uplink data and retrieves from AP 101 buffered downlink data, such operations may optionally occur in parallel. In the case of additional non-TIM STAs (e.g., non-TIM STAs beyond non-TIM STAs 107 and 109), such STAs, as a non-limiting example, may analogously dispatch buffered data and/or received buffered data from AP 101 during their corresponding TWTs.

Also according to the illustrative example, the noted dispatch of assignment to an assigned access slot group may be dispatch of assignment to a RAW and/or be from AP 101 to TIM STA 103 and/or TIM STA 1105 (e.g., via one or more beacons 111).

Further according to the illustrative example, the noted dispatch of assignment to an assigned access slot group may be dispatch of assignment to a PRAW and/or be from AP 101 to non-TIM STA 107 and/or non-TIM STA 109 (e.g., during association).

### Assigned Access Slot Group Indication—Group Block Indication Functionality

Assigned access slot group indication group block indication functionality according to at least one example embodiment will now be discussed. Via such functionality an AP may convey to a STA (e.g., a TIM STA) indication of blocks of STAs for which some or all of the STAs thereof may be members of an assigned access slot group (e.g., RAW group). As a non-limiting example, the AP may indicate STAs which are assigned to an assigned access slot group (e.g., RAW group) by indicating a range of STA identifiers (e.g., AIDs) thereof, where the identifiers include block indication (e.g., via one or more bits). As a non-limiting example, where thirteen bit AIDs—having two bits conveying a page, and eleven bits conveying block, SB, and AID address location for that page of which five of those eleven bits convey block—are employed, block for an assigned access slot group (e.g., RAW group) start AID may be indicated using three bits and/or block for an assigned access slot group (e.g., RAW group) end AID may be indicated using three bits.

As an illustrative example of such functionality, one or more STAs may receive from an AP (e.g., via one or more beacons) data corresponding to assigned access slot group (e.g., RAW group) assignment. As a non-limiting example, such data receipt may be via a RAW parameter set (RPS) information element (IE).

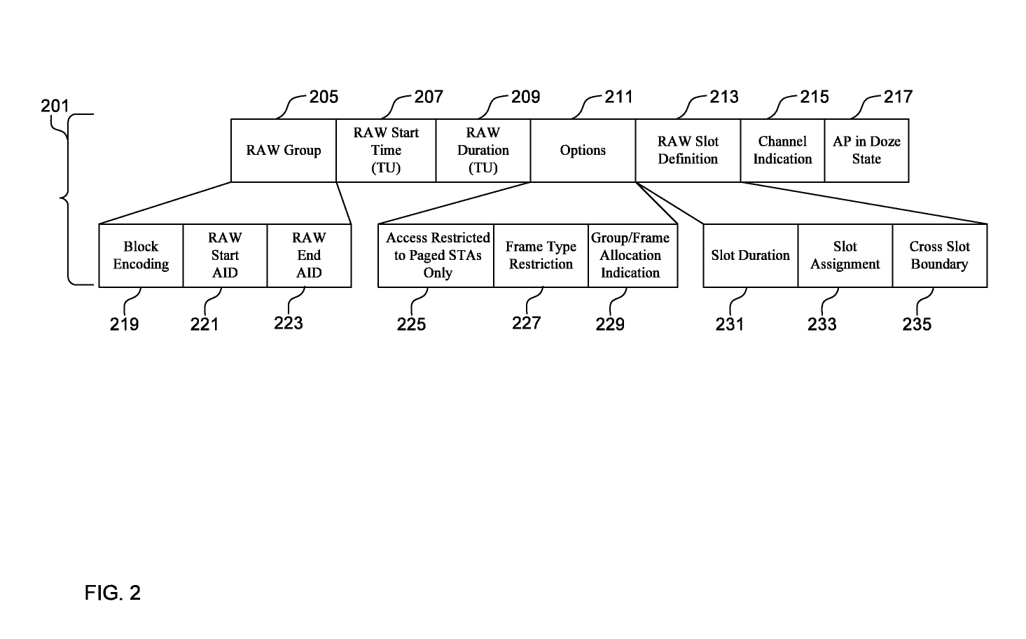

Further according to the illustrative example, FIG. 2 shows an example RPS IE according to at least one example embodiment. Included in RPS IE 201 are RAW Group sub-field 205, RAW Start Time (specified in Time Units (TU)) sub-field 207, RAW Duration sub-field 209 (specified in TU), Options sub-field 211, RAW Slot Definition sub-field 213, Channel Indication sub-field 215, and AP in Doze State sub-field 217. Sub-field 205 is a variable number of bits in length, sub-field 207 is eight bits in length, sub-field 209 is a variable number of bits in length, sub-field 211 is three bits in length, sub-field 213 is a variable number of bits in length, sub-field 215 is a variable number of bits in length, and sub-field 217 is a variable number of bits in length.

Still further according to the illustrative example, RAW Group sub-field 205 includes Block Encoding sub-sub-field 219, RAW Start AID sub-sub-field 221, and RAW End AID sub-sub-field 223. Sub-field 211 includes Access Restricted to Paged STAs Only sub-sub-field 225, Frame Type Restriction sub-sub-field 227, and Group/Frame Allocation Indication sub-sub-field 229. Sub-field 213 includes Slot Duration sub-sub-field 231, Slot Assignment sub-sub-field 233, and Cross Slot Boundary sub-sub-field 235. Sub-sub-field 219 is two bits in length, sub-sub-field 221 is seven bits in length, sub-sub-field 223 is seven bits in length, sub-sub-field 225 is one bit in length, sub-sub-field 227 is one bit in length, sub-sub-field 229 is one bit in length, sub-sub-field 231 is a variable number of bits in length, sub-sub-field 233 is a variable number of bits in length, and sub-sub-field 235 is a variable number of bits in length. As a non-limiting example, the most significant bit of Block Encoding sub-sub-field 219 may be termed first indication. As another non-limiting example, the second most significant bit of Block Encoding sub-sub-field 219 may be termed second indication. One or more of the sub-fields and/or sub-sub-fields of FIG. 2 may be located in one or more other information elements. Block encoding sub-sub-field 219 may, as a non-limiting example, serve as a replacement for a page index sub-sub-field (e.g., a page index sub-sub-field two bits in length). As a further non-limiting example, a page index sub-sub-field so replaced may be viewed as redundant from the vantage point that a STA receiving (e.g., via one or more beacons) such a page index sub-sub-field would also be in receipt (e.g., via one or more same and/or different beacons) of page indication provided thereby via one or more other venues (e.g., via a page index field of a segment count IE and/or other IE).

Also according to the illustrative example, the AP may dispatch to a STA information including indication of a group start STA identifier (e.g., RAW start AID) with respect to a specified page, a group end STA identifier (e.g., RAW end AID) with respect to that specified page, and information employable in interpreting some or all of that group start STA identifier information and/or that group end STA identifier information. As a non-limiting example, the AP may provide to that STA such page specification via a field (e.g., a two-bit field) of a first information element (e.g., a segment count IE), such group start identifier via a sub-sub-field (e.g., the noted RAW start AID sub-sub-field) of a second IE (e.g., an RPS IE), and/or such information employable in interpreting via a sub-sub-field (e.g., the noted block encoding sub-sub-field) of that second IE (e.g., that RPS IE). The information employable in interpreting may be information employable in interpreting a portion of (e.g., page bits of) that group start identifier and/or that group end identifier. The first IE and the second IE may be sent via the same beacon and/or via different beacons. As a non-limiting example, the AP may select some or all of—for instance a page portion of, a block portion of, a SB portion of, and/or an address location portion of—the group start STA identifier (e.g., RAW start AID). As a further non-limiting example, the AP may select some or all of—for instance a page portion of, a block portion of, a SB portion of, and/or an address location portion of—the group end STA identifier (e.g., RAW end AID).

Additionally according to the illustrative example, in preparing such dispatch the AP may consider with respect to the group start STA identifier (e.g., RAW start AID) which may be conveyed and/or the group end STA identifier (e.g., RAW end AID) which may be conveyed a value which, as a non-limiting example, may be termed commencing block, a value which, as a non-limiting example, may be termed terminal block, and/or a value which, as a non-limiting example, may be termed middle block.

Also according to the illustrative example, as a non-limiting example (e.g., employed where there may be one RPS IE per entire page, where the page may or may not be split into page segments), terminal block may be taken as the number of blocks per page (e.g., thirty-two), the middle block number may be calculated as half the number of blocks per page (e.g., sixteen), and/or commencing block may be taken as the first block of the page (e.g., one).

Additionally according to the illustrative example, as a non-limiting example (e.g., employed where there may be one RPS IE per page segment), commencing block may be taken as TIM segment start. Such TIM segment start may be calculated as:

TIM segment start=page offset+(length of page segment·(TIM segment number−1))+1

where page offset is received via page segment count IE, length of page segment is calculated as the number of blocks per page within the relevant hierarchy (e.g., thirty-two blocks per page) divided by the page segment count with the page segment count being via the page segment count IE, and TIM segment number is received via TIM IE (e.g., where there may be one RPS IE per page segment, the TIM IE segment corresponding to that page segment).

Further according to the illustrative example, as a non-limiting example (e.g., employed where there may be one RPS IE per page segment), terminal block may be taken as TIM segment end. Such TIM segment end may be calculated as:

TIM segment end=page offset+length of page segment·TIM segment number

where page offset is as above with respect to calculation of TIM segment start, length of page segment is as above with respect to calculation of TIM segment start, and TIM segment number is received via TIM IE (e.g., where there may be one RPS IE per page segment, the TIM IE segment corresponding to that page segment).

Still further according to the illustrative example, as a non-limiting example (e.g., employed where there may be one RPS IE per page segment), middle block may be taken as TIM mid segment. As one non-limiting example (e.g., employed where there may be one RPS IE per page segment), such TIM mid segment may be calculated as:

$$\frac{\begin{matrix}total number of blocks in a page \\ segment served in a TIM segment\end{matrix} }{2}$$

As an yet another non-limiting example (e.g., employed where there may be one RPS IE per page segment), such TIM mid segment may be calculated as:

$$\frac{( TIM segment end - TIM segment start ) + 1}{2} + TIM segment start - 1$$

Also according to the illustrative example, there may be assumption that there will not be indication of a group start STA identifier (e.g., RAW start AID) for which the block portion (e.g., block bits) thereof indicates a block having a block number higher than the middle block number (e.g., that there will not be indication of a group start STA identifier for which the block portion thereof indicates a block number higher than sixteen in the case where the middle block number is sixteen).

Additionally according to the illustrative example, there may be assumption that there will not be indication of a group end STA identifier (e.g., RAW end AID) for which the block portion (e.g., block bits) thereof indicates a block having a block number lower than one greater than the middle block number (e.g., that there will not be indication of a group end STA identifier for which the block portion thereof indicates a block number lower than seventeen in the case where the middle block number is sixteen).

Also according to the illustrative example, in connection with conveying a group start STA identifier (e.g., a RAW start AID) to a STA, the AP may consider whether the block portion (e.g., block bits) of such a group start identifier indicates a block closer to the commencing block or to the middle block. It is noted that indication of block by block bits may be such that, taking block number one to be the first block, the block number range 1 through n may be conveyed via bits corresponding to range 0 through (n−1). As a non-limiting example, where block numbers may range from 1 through 32, corresponding bits (e.g., AID bits) may range from 0 through 31 (e.g., 00000 through 11111 binary). Where the block portion indicates a block that is closer to commencing block, the AP may encode the block bits as encoded_block_start, where encoded_block_start is set so that:

commencing block+encoded_block_start

resolves to the block number of the block indicated by the block portion (e.g., block bits) of the group start identifier.

Additionally according to the illustrative example, where the block portion indicates a block that is closer to middle block, the AP may encode the block bits as encoded_block_start, where encoded_block_start is set so that:

middle block−encoded_block_start

resolves to the block number of the block indicated by the block portion (e.g., block bits) of the group start identifier.

Also according to the illustrative example, the AP may indicate the set encoded_block_start to the STA and/or may indicate whether encoded_block_start was set with reference to the commencing block or with reference to the middle block. As a non-limiting example, the AP may indicate the set encoded_block_start to the STA by specifying it as bits of the RAW start AID sub-sub-field (e.g., as the three most significant bits of the RAW start AID sub-sub-field). As another non-limiting example, the AP may indicate to the STA whether encoded_block_start was set with reference to the commencing block or with reference to the middle block by specifying such as a bit of the block encoding sub-sub-field (e.g., via the most significant bit of the block encoding sub-sub-field). As a non-limiting example, a bit value of zero (e.g., binary 0) may be employed to indicate reference to the commencing block and/or a bit value of one (e.g., binary 1) may be employed to indicate reference to the middle block.

Further according to the illustrative example, returning to discussion of circumstance where the block portion (e.g., block bits) of the group start identifier indicates a block which is closer to the commencing block than the middle block, as a non-limiting example where the commencing block is the first block, the middle block is the sixteenth block, and the block portion of the group start identifier indicates the third block, encoded_block_start may be set as two such that the equation resolves as:

1+2=3.

Still further according to the illustrative example, as a non-limiting example the AP may indicate the encoded_block_start of two to the STA by setting bits of the RAW start AID sub-sub-field (e.g., the three most significant bits thereof) to two (e.g., binary 010), and/or may indicate that encoded_block_start was set with reference to the commencing block by setting a bit of the block encoding sub-sub-field (e.g., the most significant bit thereof) to zero (e.g., binary 0).

Also according to the illustrative example, returning to discussion of circumstance where the block portion (e.g., block bits) of the group start identifier indicates a block which is closer to middle block than to the commencing block, as a non-limiting example, where the commencing block is the first block, the middle block is the sixteenth block, and the block portion of the group start identifier indicates the thirteenth block, encoded_block_start may be set as three such that the equation resolves as:

16−3=13.

Additionally according to the illustrative example, as a non-limiting example the AP may indicate the encoded_block_start of three to the STA by setting bits of the RAW start AID sub-sub-field (e.g., the three most significant bits thereof) to three (e.g., binary 011) and/or may indicate that encoded_block_start was set with reference to the middle block by setting a bit of the block encoding sub-sub-field to one (e.g., binary 1).

Also according to the illustrative example, in connection with conveying a group end STA identifier (e.g., a RAW end AID) to a STA, the AP may consider whether the block portion (e.g., block bits) of such a group end identifier indicates a block closer to one greater than the middle block or to the terminal block. Determination of which of the terminal block and one greater than the middle block is closer, as discussed herein, may, as one non-limiting example, be performed by comparing closeness to the terminal block with closeness to one greater than the middle block. According to another non-limiting example, such determination, as discussed herein, may be performed by comparing closeness to the terminal block with closeness to the middle block. It is noted that indication of block by block bits may be such that, taking block number one to be the first block, the block number range 1 through n may be conveyed via bits corresponding to range 0 through (n−1). Where the block portion indicates a block that is closer to one greater than middle block, the AP may encode the block bits as encoded_block_end, where encoded_block_end is set so that:

(middle block+1)+encoded_block_end

resolves to the block number of the block indicated by the block portion (e.g., block bits) of the group end identifier.

Additionally according to the illustrative example, where the block portion indicates a block that is closer to terminal block, the AP may encode the block bits as encoded_block_end, where encoded_block_end is set so that:

terminal block−encoded_block_end

resolves to the block number of the block indicated by the block portion (e.g., block bits) of the group end identifier.

Also according to the illustrative example, the AP may indicate the set encoded_block_end to the STA and/or may indicate whether encoded_block_end was set with reference to one greater than the middle block or with reference to the terminal block. As a non-limiting example, the AP may indicate the set encoded_block_end to the STA by specifying it as bits of the RAW end AID sub-sub-field (e.g., as the three most significant bits of the RAW end AID sub-sub-field). As another non-limiting example, the AP may indicate to the STA whether encoded_block_end was set with reference to one greater than the middle block or with reference to the terminal block by specifying such as a bit of the block encoding sub-sub-field (e.g., via the second most significant bit of the block encoding sub-sub-field). As a non-limiting example, a bit value of one (e.g., binary 1) may be employed to indicate reference to one greater than middle block and/or a bit value of zero (e.g., binary 0) may be employed to indicate reference to the terminal block.

Further according to the illustrative example, returning to discussion of circumstance where the block portion (e.g., block bits) of the group end identifier indicates a block which is closer to one greater than the middle block than the terminal block, as a non-limiting example where the middle block is the sixteenth block, the terminal block is the thirty-second block, and the block portion of the group end identifier indicates the nineteenth block, encoded_block_end may be set as two such that the equation resolves as:

(16+1)+2=17+2=19.

Still further according to the illustrative example, as a non-limiting example the AP may indicate the encoded_block_end of two to the STA by setting bits of the RAW end AID sub-sub-field (e.g., the three most significant bits thereof) to two (e.g., binary 010), and/or may indicate that encoded_block_end was set with reference to one greater than the middle block by setting a bit of the block encoding sub-sub-field (e.g., the second most significant bit thereof) to one (e.g., binary 1).

Also according to the illustrative example, returning to discussion of circumstance where the block portion (e.g., block bits) of the group end identifier indicates a block which is closer to terminal block than to one greater than the middle block, as a non-limiting example, where the middle block is the sixteenth block, the terminal block is the thirty-second block, and the block portion of the group end identifier indicates the twenty-ninth block, encoded_block_end may be set as three such that the equation resolves as:

32−3=29.

Additionally according to the illustrative example, as a non-limiting example the AP may indicate the encoded_block_end of three to the STA by setting bits of the RAW end AID sub-sub-field (e.g., the three most significant bits thereof) to three (e.g., binary 011) and/or may indicate that encoded_block_end was set with reference to the terminal block by setting a bit of the block encoding sub-sub-field to zero (e.g., binary 0).

Further according to the illustrative example, the STA may receive from the AP indication of the set encoded_block_start, indication of whether encoded_block_start was set with reference to commencing block or with reference to middle block, indication of the set encoded_block_end, and/or indication of whether encoded_block_end was set with reference to one greater than the middle block or with reference to the terminal block. As non-limiting examples, the STA may receive the indication of the set encoded_block_start via three bits (e.g., three most significant bits) of a RAW start AID sub-sub-field received via RPS IE, may receive the indication of whether encoded_block_start was set with reference to commencing block or with reference to the middle block via one bit (e.g., the most significant bit) of a block encoding sub-sub-field received via RPS IE, may receive the indication of the set encoded_block_end via three bits (e.g., three most significant bits) of a RAW end AID sub-sub-field received via RPS IE, and/or may receive the indication of whether encoded_block_end was set with reference to one greater than the middle block or with reference to the terminal block via one bit (e.g., the second most significant bit) of the block encoding sub-sub-field received via RPS IE.

Still further according to the illustrative example, the STA may, in agreement with the AP functionality discussed above, interpret the indication of whether encoded_block_start was set with reference to commencing block or with reference to middle block. In view of that the STA may, in agreement with the AP functionality discussed above, calculate the appropriate one of:

commencing block+encoded_block_start; and

middle block−encoded_block_start

in order to learn the block portion (e.g., block bits) of the group start identifier (e.g., of the RAW start AID). As a non-limiting example, the STA may know the values of commencing block and/or of middle block by performance of operations in agreement with those discussed in connection with the AP.

Additionally according to the illustrative example, the STA may, in agreement with the AP functionality discussed above, interpret the indication of whether encoded_block_end was set with reference to one greater than the middle block or with reference to the terminal block. In view of that the STA may, in agreement with the AP functionality discussed above, calculate the appropriate one of:

(middle block+1)+encoded_block_end; and

terminal block−encoded_block_end

in order to learn the block portion (e.g., block bits) of the group end identifier (e.g., of the RAW end AID). As a non-limiting example, the STA may know the values of middle block and/or of terminal block by performance of operations in agreement with those discussed in connection with the AP.

### Assigned Access Slot Group Indication—Group Sub-Block and Address Location Indication Functionality

Assigned access slot group indication group sub-block and address location indication functionality according to at least one example embodiment will now be discussed. Via such functionality an AP may convey to a STA (e.g., a TIM STA) indication of SBs and/or address locations (e.g., AID address locations) of STAs for which some or all of the STAs thereof may be members of an assigned access slot group (e.g., RAW group). As a non-limiting example, the AP may indicate STAs which are assigned to an assigned access slot group (e.g., RAW group) by indicating a range of STA identifiers (e.g., AIDs) thereof, where the identifiers include SB indication and/or address location (e.g., AID address location) indication (e.g., via one or more bits). As a non-limiting example, where thirteen bit AIDs—having two bits conveying a page, and eleven bits conveying block, SB, and AID address location for that page of which three of those eleven bits convey SB—are employed, SB for an assigned access slot group (e.g., RAW group) start AID may be indicated using two bits and/or SB for an assigned access slot group (e.g., RAW group) end AID may be indicated using two bits. As another non-limiting example, where thirteen bit AIDs—having two bits conveying a page, and eleven bits conveying block, SB, and AID address location for that page of which three of those eleven bits convey AID address location—are employed, AID address location for an assigned access slot group (e.g., RAW group) start AID may be indicated using two bits and/or AID address location for an assigned access slot group (e.g., RAW group) end AID may be indicated using two bits.

As an illustrative example of such functionality, one or more STAs may receive from an AP (e.g., via one or more beacons) data corresponding to assigned access slot group (e.g., RAW group) assignment. As a non-limiting example, such data receipt may be via a RPS IE and/or via segment count IE.

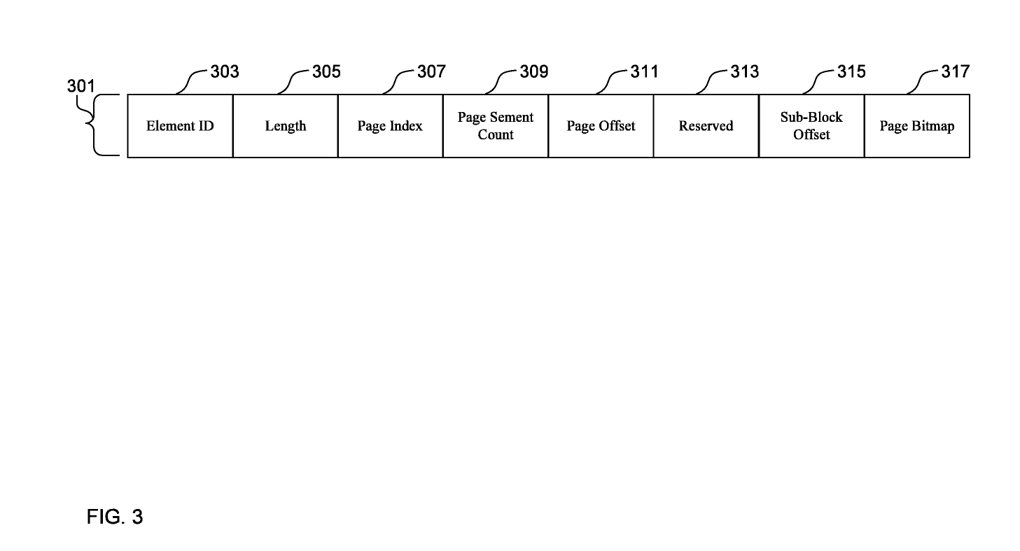

Further according to the illustrative example, the RPS IE may be as discussed hereinabove with respect to FIG. 2. The segment count IE may be as will now be discussed with respect to FIG. 3. FIG. 3 shows an example segment count IE according to at least one example embodiment. Included in segment count IE 301 are element ID field 303, length field 305, page index field 307, page segment count field 309, page offset field 311, reserved 313, SB offset field 315, and page bitmap field 317. Field 303 is eight bits in length, field 305 is eight bits in length, field 307 is two bits in length, field 309 is five bits in length, field 311 is five bits in length, reserved 313 is one bit in length, field 315 is a three bits in length, and field 317 is between zero and thirty-two bits in length. One or more of the fields of FIG. 3 may be located in one or more other information elements. SB offset field 315 may, as a non-limiting example, serve as a replacement for bits previously considered reserved.

Still further according to the illustrative example, the SB offset field may serve to provide information regarding AP-buffered data awaiting STAs. The SB offset field may be formulated by the AP to specify the first SB, of the block referenced by the page offset, for which at least one STA thereof has buffered data awaiting it at the AP, thereby indicating the for each preceding SB no STA thereof has awaiting AP-buffered data. The page bitmap field may be formulated by the AP to contain for each block, of the page indicated by page index, indication (e.g., one bit) as to whether or not any of the STAs of that block have buffered data awaiting them at the AP. As a non-limiting example, the nth bit of the page bitmap field may correspond to the nth block of the page indicated by the page index. As a further non-limiting example, a bit value of one may be employed to convey, with respect to a block, buffered data presence at the AP whilst a bit value of zero may be employed to convey, with respect to a block, buffered data absence at the AP. In the case where no SB of the block indicated by page offset has buffered data awaiting it at the AP, the AP may set the page bitmap field to indicate no AP-buffered data with respect to that block, and the value set by the AP for SB offset may be unimportant. A STA receiving a page bitmap field that indicates no AP-buffered data with respect to the block indicated by page offset may determine that no STA of that block has waiting AP-buffered data, and may ignore and/or not act upon the contents of the SB offset field.

Additionally according to the illustrative example, a STA, receiving (e.g., via one or more beacons) the page bitmap field and learning therefrom that no STAs of its block have awaiting AP-buffered data, may, in response thereto, enter a low power mode (e.g., a sleep mode). A STA, receiving (e.g., via one or more beacons) the SB offset field and learning therefrom that no STAs of its SB have awaiting AP-buffered data, may, in response thereto, enter a low power mode (e.g., a sleep mode). It is noted that indication of SB number by SB offset may be such that, taking SB number one to be the first SB, the SB number range 1 through n may be conveyed via bits corresponding to the range 0 through (n−1).

Further according to the illustrative example, the AP and/or the STA may consider a value which, as a non-limiting example, may be termed SB reference and/or a value which, as a non-limiting example, may be termed address location reference.

Still further according to the illustrative example, as a non-limiting example (e.g., employed where there may be one RPS IE per entire page, where the page may or may not be split into page segments), the AP and/or the STA may calculate SB reference as half of the number of SBs per block (e.g., four in the case of eight SBs per block). As another non-limiting example (e.g., employed where there may be one RPS IE per entire page, where the page may or may not be split into page segments), the AP and/or the STA may calculate address location reference as half of the number of address locations (e.g., AID address locations) per SB (e.g., four in the case of eight address locations per SB).

Also according to the non-limiting example as a further non-limiting example (e.g., employed where there may be one RPS IE per page segment), the AP and/or STA may calculate SB reference as one quarter of the above-discussed middle block—for instance TIM mid segment/4—(e.g., four in the case of a middle block of sixteen), and/or may calculate address location reference as one quarter of the above-discussed middle block—for instance TIM mid segment/4—(e.g., four in the case of a middle block of sixteen).

Still further according to the illustrative example, the AP may include in the discussed indication of group start STA identifier (e.g., of RAW start AID), which the AP dispatches to the STA, a value encoded_SB_start which conveys the SB portion of the group start STA identifier. As a non-limiting example, in the case where the STA identifier (e.g., AID) employs three bits to indicate SB, encoded_SB_start may be two bits in length. As a non-limiting example, encoded_SB_start may make up two bits of the RAW start AID sub-sub-field (e.g., the fourth and fifth most significant bits thereof).

Additionally according to the illustrative example, in setting encoded_SB_start the AP may compare SB reference with the SB number indicated by SB offset (e.g., an SB number of n+1 in the case of a SB offset of n). In the case where the AP finds:

SB reference≧the SB number indicated by SB offset

to resolve to true, the AP may set encoded_SB_start to indicate a group start STA identifier SB portion having a SB number less than or equal to SB reference (e.g., having a SB number less than or equal to four in the case of a SB reference of four). The AP may so set by—from the vantage point of SB numbers ranging from 1 through n being expressed via the range 0 through (n−1)—setting encoded_SB_start such that its bits hold the bits remaining after eliminating, from the group start STA identifier SB portion to be indicated, one or more most significant bits of zero value. As a non-limiting example, where the STA identifier employs three bits to indicate SB, encoded_SB_start is two bits in length, and a SB number of three is to be indicated (010 binary from the noted vantage point), encoded_SB_start (from the noted vantage point) may be set as 10 binary. It is noted that indication of SB number by encoded_SB_start may be such that, taking SB number one to be the first SB, the SB number range 1 through n may be conveyed via bits corresponding to the range 0 through (n−1).

Also according to the illustrative example, in the case where the AP finds:

SB reference<the SB number indicated by SB offset

to resolve to true, the AP may set encoded_SB_start to indicate a group start STA identifier SB portion having a SB number greater than SB reference (e.g., having a SB number greater than four in the case of a SB reference of four). The AP may—from the vantage point of SB numbers ranging from 1 through n being expressed via the range 0 through (n−1)—set encoded_SB_start such that:

SB reference+encoded_SB_start=group start STA identifer SB portion.

Further according to the illustrative example, it is noted that, as a non-limiting example, direct representation of the group start STA identifier to be indicated may call for a greater number of bits than the bit length of encoded_SB_start (e.g., such direct representation may call for three bits whilst encoded_SB_start may be two bits in length).

Still further according to the illustrative example, as a non-limiting example, where STA identifier employs three bits to indicate SB, encoded_SB_start is two bits in length, and a SB number of six is to be indicated (101 binary from the noted vantage point), encoded_SB_start (from the noted vantage point) may be set as 01 binary.

Also according to the illustrative example, it is noted according to at least one alternative example embodiment, in the case where the AP finds:

SB reference≧the SB number indicated by SB offset

to resolve to true, the AP may set—in agreement with that which is set forth above—encoded_SB_start to indicate a group start STA identifier SB portion having a SB number greater than SB reference (e.g., having a SB number greater than four in the case of a SB reference of four) and in the case where the AP finds:

SB reference<SB number indicated by SB offset

to resolve to true the AP may set—in agreement with that which is set forth above—encoded_SB_start to indicate a group start STA identifier SB portion having a SB number less than or equal to SB reference (e.g., having a SB number less than or equal to four in the case of a SB reference of four).

Still further according to the illustrative example, the AP may include in the discussed indication of group end STA identifier (e.g., of RAW end AID), which the AP dispatches to the STA, a value encoded_SB_end which conveys the SB portion of the group end STA identifier. As a non-limiting example, in the case where the STA identifier (e.g., AID) employs three bits to indicate SB, encoded_SB_end may be two bits in length. As a non-limiting example, encoded_SB_end may make up two bits of the RAW end AID sub-sub-field (e.g., the fourth and fifth most significant bits thereof).

Additionally according to the illustrative example, in setting encoded_SB_end the AP may compare SB reference with the SB number indicated by SB offset (e.g., an SB number of n+1 in the case of a SB offset of n). In the case where the AP finds:

SB reference≧the SB number indicated by SB offset

to resolve to true, the AP may set—in a manner analogous to that set forth above—encoded_SB_end to indicate a group end STA identifier SB portion having a SB number less than or equal to SB reference (e.g., having a SB number less than or equal to four in the case of a SB reference of four). It is noted that indication of SB number by encoded_SB_end may be such that, taking SB number one to be the first SB, the SB number range 1 through n may be conveyed via bits corresponding to the range 0 through (n−1).

Also according to the illustrative example, in the case where the AP finds:

SB reference<the SB number indicated by SB offset

to resolve to true, the AP may set—in a manner analogous to that set forth above—encoded_SB_end to indicate a group end STA identifier SB portion having a SB number greater than SB reference (e.g., having a SB number greater than four in the case of a SB reference of four).

Also according to the illustrative example, it is noted according to at least one alternative example embodiment, in the case where the AP finds:

SB reference≧the SB number indicated by SB offset

to resolve to true, the AP may set—in agreement with that which is set forth above—encoded_SB_end to indicate a group end STA identifier SB portion having a SB number greater than SB reference (e.g., having a SB number greater than four in the case of a SB reference of four) and in the case where the AP finds:

SB reference<SB number indicated by SB offset

to resolve to true the AP may set—in agreement with that which is set forth above—encoded_SB_end to indicate a group end STA identifier SB portion having a SB number less than or equal to SB reference (e.g., having a SB number less than or equal to four in the case of a SB reference of four).

Still further according to the illustrative example, the AP may include in the discussed indication of group start STA identifier (e.g., of RAW start AID), which the AP dispatches to the STA, a value encoded_address location_start which conveys the address location portion of the group start STA identifier. As a non-limiting example, in the case where the STA identifier (e.g., AID) employs three bits to indicate address location, encoded_address location_start may be two bits in length. As a non-limiting example, encoded_address location_start may make up two bits of the RAW start AID sub-sub-field (e.g., the sixth and seventh most significant bits thereof).

Additionally according to the illustrative example, in setting encoded_address location_start the AP may compare address location reference with the address location number indicated by SB offset (e.g., an SB number of n+1 in the case of a SB offset of n). In the case where the AP finds:

address location reference≧the SB number indicated by SB offset

to resolve to true, the AP may set—in a manner analogous to that set forth above—encoded_address location_start to indicate a group start STA identifier address location portion having an address location number less than or equal to address location reference (e.g., having an address location number less than or equal to four in the case of an address location reference of four). It is noted that indication of address location number by encoded_address location_start may be such that, taking address location number one to be the first address location, the address location number range 1 through n may be conveyed via bits corresponding to the range 0 through (n−1).

Also according to the illustrative example, in the case where the AP finds:

address location reference<the SB number indicated by SB offset

to resolve to true, the AP may set—in a manner analogous to that set forth above—encoded_address location_start to indicate a group start STA identifier address location portion having an address location number greater than address location reference (e.g., having an address location number greater than four in the case of an address location reference of four).

Also according to the illustrative example, it is noted according to at least one alternative example embodiment, in the case where the AP finds:

address location reference≧the SB number indicated by SB offset

to resolve to true, the AP may set—in agreement with that which is set forth above—encoded_address location_start to indicate a group start STA identifier address location portion having an address location number greater than address location reference (e.g., having an address location number greater than four in the case of an address location reference of four) and in the case where the AP finds:

address location reference<SB number indicated by SB offset

to resolve to true the AP may set—in agreement with that which is set forth above—encoded_address location_start to indicate a group start STA identifier address location portion having an address location number less than or equal to address location reference (e.g., having an address location number less than or equal to four in the case of an address location reference of four).

Still further according to the illustrative example, the AP may include in the discussed indication of group end STA identifier (e.g., of RAW end AID), which the AP dispatches to the STA, a value encoded_address location_end which conveys the address location portion of the group end STA identifier. As a non-limiting example, in the case where the STA identifier (e.g., AID) employs three bits to indicate address location, encoded_address location_end may be two bits in length. As a non-limiting example, encoded_address location_end may make up two bits of the RAW end AID sub-sub-field (e.g., the six and seventh most significant bits thereof).

Additionally according to the illustrative example, in setting encoded_address location_end the AP may compare address location reference with the address location number indicated by SB offset (e.g., an SB number of n+1 in the case of a SB offset of n). In the case where the AP finds:

address location reference≧the SB number indicated by SB offset

to resolve to true, the AP may set—in a manner analogous to that set forth above—encoded_address location_end to indicate a group end STA identifier address location portion having an address location number less than or equal to address location reference (e.g., having an address location number less than or equal to four in the case of an address location reference of four). It is noted that indication of address location number by encoded_address location_end may be such that, taking address location number one to be the first address location, the address location number range 1 through n may be conveyed via bits corresponding to the range 0 through (n−1).

Also according to the illustrative example, in the case where the AP finds:

address location reference<the SB number indicated by SB offset

to resolve to true, the AP may set—in a manner analogous to that set forth above—encoded_address location_end to indicate a group end STA identifier address location portion having an address location number greater than address location reference (e.g., having an address location number greater than four in the case of an address location reference of four).

Also according to the illustrative example, it is noted according to at least one alternative example embodiment, in the case where the AP finds:

address location reference≧the SB number indicated by SB off set

to resolve to true, the AP may set—in agreement with that which is set forth above—encoded_address location_end to indicate a group end STA identifier address location portion having an address location number greater than address location reference (e.g., having an address location number greater than four in the case of an address location reference of four) and in the case where the AP finds:

address location reference<SB number indicated by SB off set

to resolve to true the AP may set—in agreement with that which is set forth above—encoded_address location_end to indicate a group end STA identifier address location portion having an address location number less than or equal to address location reference (e.g., having an address location number less than or equal to four in the case of an address location reference of four).

Further according to the illustrative example, the STA may receive from the AP indication of SB offset, indication of the set encoded_SB_start, indication of the set encoded_SB_end, indication of the set encoded_address location_start, and/or indication of the set encoded_address location_end. As a non-limiting example, the STA may receive the indication of SB offset via the SB offset field of the segment count IE, may receive the indication of the set encoded_SB_start via two bits (e.g., the fourth and fifth most significant bits) of the RAW start AID sub-sub-field via RPS IE, may receive the indication of the set encoded_SB_end via two bits (e.g., the fourth and fifth most significant bits) of the RAW end AID sub-sub-field received via RPS IE, indication of the encoded_address location_start via two bits (e.g., the sixth and seventh most significant bits) of the RAW start AID sub-sub-field via RPS IE, and/or may receive the indication of the set encoded_address location_end via two bits (e.g., the sixth and seventh most significant bits) of the RAW end AID sub-sub-field received via RPS IE.

Still further according to the illustrative example, the STA may, in agreement with the AP functionality discussed above, compare SB reference with the SB number indicated by SB offset to determine whether encoded_SB_start should be interpreted as indicating a group start STA identifier SB portion having an SB number less than or equal to SB reference (e.g., having an SB number less than or equal to four in the case of an SB reference of four), or whether encoded_SB_start should be interpreted as indicating a group start STA identifier SB portion having an SB number greater than SB reference (e.g., having an SB number greater than four in the case of an SB reference of four). In view of that the STA may, in agreement with the AP functionality discussed above, determine the group start STA identifier SB portion indicated by encoded_SB_start.

Additionally further according to the illustrative example, the STA may, in agreement with the AP functionality discussed above, compare SB reference with the SB number indicated by SB offset to determine whether encoded_SB_end should be interpreted as indicating a group end STA identifier SB portion having an SB number less than or equal to SB reference (e.g., having an SB number less than or equal to four in the case of an SB reference of four), or whether encoded_SB_end should be interpreted as indicating a group end STA identifier SB portion having an SB number greater than SB reference (e.g., having an SB number greater than four in the case of an SB reference of four). In view of that the STA may, in agreement with the AP functionality discussed above, determine the group end STA identifier SB portion indicated by encoded_SB_end.

Also further according to the illustrative example, the STA may, in agreement with the AP functionality discussed above, compare address location reference with the SB number indicated by SB offset to determine whether encoded_address location_start should be interpreted as indicating a group start STA identifier address location portion having an address location number less than or equal to address location reference (e.g., having an address location number less than or equal to four in the case of an address location reference of four), or whether encoded_address location_start should be interpreted as indicating a group start STA identifier address location portion having an address location number greater than address location reference (e.g., having an address location number greater than four in the case of an address location reference of four). In view of that the STA may, in agreement with the AP functionality discussed above, determine the group start STA identifier address location portion indicated by encoded_address location_start.

Further according to the illustrative example, the STA may, in agreement with the AP functionality discussed above, compare address location reference with the SB number indicated by SB offset to determine whether encoded_address location_end should be interpreted as indicating a group end STA identifier address location portion having an address location number less than or equal to address location reference (e.g., having an address location number less than or equal to four in the case of an address location reference of four), or whether encoded_address location_end should be interpreted as indicating a group end STA identifier address location portion having an address location number greater than address location reference (e.g., having an address location number greater than four in the case of an address location reference of four). In view of that the STA may, in agreement with the AP functionality discussed above, determine the group end STA identifier address location portion indicated by encoded_address location_end.

Also according to the illustrative example, the AP, according to the noted alternative embodiment, looking to set encoded_SB_start or encoded_SB_end and facing a SB offset indicating a SB number of six and there being a SB reference of four, may compare the SB reference—four—with the number—six—indicated by SB offset and determine:

SB reference<SB number indicated by SB offset

to evaluate to true.

Further according to the illustrative example, the AP may set encoded_SB_start or encoded_SB_end to indicate a group start STA identifier or group end STA identifier SB portion having a SB number less than or equal to the SB reference value of four. As such the AP may elect to set the encoded_SB_start or encoded_SB_end to indicate a group start STA identifier or group end STA identifier SB portion having a SB number of four. As such, the AP may set two bits of the encoded_SB_start or encoded_SB_end to 11 binary.

Still further according to the illustrative example, the STA, according to the noted alternative embodiment, may perform the comparison performed by the AP and, like the AP, find the noted equation to evaluate to true. In view of the equation evaluating to true the STA may determine that the encoded_SB_start or encoded_SB_end should be interpreted as indicating the appropriate one of a group start STA identifier SB portion or a group end STA identifier SB portion having a SB number less than or equal to the SB reference of four. As such, the STA may consider the two bits 11 to convey a SB number of four.

Also according to the illustrative example, the AP, according to the noted alternative embodiment, looking to set encoded_SB_start or encoded_SB_end and facing a SB offset indicating a SB number of two and there being a SB reference of four, may compare the SB reference—four—with the number—two—indicated by SB offset and determine:

SB reference≧SB number indicated by SB offset

to evaluate to true.

Further according to the illustrative example, the AP may set encoded_SB_start or encoded_SB_end to indicate a group start STA identifier or group end STA identifier SB portion having a SB number greater than the SB reference value of four. As such the AP may elect to set the encoded_SB_start or encoded_SB_end to indicate a group start STA identifier or group end STA identifier SB portion having a SB number of six. As such, the AP may set two bits of the encoded_SB_start or encoded_SB_end to 01 binary.

Still further according to the illustrative example, the STA, according to the noted alternative embodiment, may perform the comparison performed by the AP and, like the AP, find the noted equation to evaluate to true. In view of the equation evaluating to true the STA may determine that the encoded_SB_start or encoded_SB_end should be interpreted as indicating the appropriate one of a group start STA identifier SB portion or a group end STA identifier SB portion having a SB number greater than the SB reference of four. As such, the STA may consider the two bits 01 to convey a SB number of six.

Also according to the illustrative example, as referenced, according to at least one example embodiment, in the case where:

SB reference≧SB number indicated by SB offset

resolves to true, encoded_SB_start may indicate a group start STA identifier SB portion having a SB number less than or equal to SB reference, and/or encoded_SB_end may indicate a group end STA identifier SB portion having a SB number less than or equal to SB reference.

Further according to the illustrative example, as referenced, according to at least one example embodiment in the case where:

SB reference<SB number indicated by SB offset

resolves to true, encoded_SB_start may include a group start STA identifier SB portion having a SB number greater than SB reference, and/or encoded_SB_end may indicate a group end STA identifier SB portion having a SB number greater than SB reference.

Still further according to the illustrative example, as a non-limiting example such functionality may be from the vantage point that the referenced group (e.g., RAW group) corresponds to a window which is a certain number of SBs in width, with that SB width being insufficient to satisfy all of a certain set of SBs (e.g., all SBs of the one or more page segments having corresponding TIM segments within a beacon period). Such insufficiency may yield a circumstance wherein the window can be viewed as shiftable relative to the SBs which it may potentially serve such that shifting the window towards certain of the SBs (e.g., towards SBs of one or more page segments to be served by one or more TIM segments later in a beacon period) may cause the window to shift away from others of the SBs (e.g., away from SBs of one or more page segments to be served by one or more TIM segments earlier in the beacon period). And, where shifting the window in the opposite direction has an opposite effect.

Additionally according to the illustrative example, as such, in either case certain SBs may be served by the window at the expense of other SBs not being served by the window. SB offset indicating AP-buffered-data-presence with respect to lower-numbered SBs of the block indicated by block offset may, under the circumstance where having AP-buffered data waiting suggests a potential call for window service (e.g., being served by a RAW), be rationale for shifting the window towards those lower-numbered SBs. Such may justify the encoded_SB_start and/or encoded_SB_end functionality, applicable for instance to setting and/or interpreting one or more of those values, just referenced. Moreover, such an approach may be leveraged with respect to address locations, thus potentially yielding, as a non-limiting example, the above-discussed corresponding functionality applicable, for instance, to setting and/or interpreting encoded_address location_start and/or encoded_address location_end.

Also according to the illustrative example, there may be circumstance where having AP-buffered data waiting suggests against a potential call for window service (e.g., by a RAW). As a non-limiting example, such circumstance may arise where having AP-buffered data waiting is indicative of being entitled to medium access by means other than by the window (e.g., by other than the RAW). As such, such circumstance may be rationale for shifting the window away from those lower-numbered SBs. Such may justify the above-discussed functionality according to at least one alternative example embodiment wherein in the case where:

SB reference≧SB number indicated by SB offset

resolves to true, encoded_SB_start may indicate a group start STA identifier SB portion having a SB number greater than SB reference, and/or encoded_SB_end may indicate a group end STA identifier SB portion having a SB number greater than SB reference, and/or where:

SB reference<SB number indicated by SB offset

resolves to true, encoded_SB_start may include a group start STA identifier SB portion having a SB number less than or equal to SB reference, and/or encoded_SB_end may indicate a group end STA identifier SB portion having a SB number less than or equal to SB reference.

Further according to the illustrative example, such an approach may be leveraged with respect to the address locations, thus potentially yielding, as a non-limiting example, the above-identified corresponding functionality applicable, for instance, to setting and/or interpreting encoded_address location_start and/or encoded_address location_end.

Also according to the illustrative example, with reference to the above-discussed AP and STA functionality, in the case where the quantity of SBs per block is not equal to the quantity of address locations per SB, a scaling may be employed when employing SB offset in connection with encoded_address location_start and/or encoded_address location_end. To wit, the SB offset—as employed in connection with encoded_address location_start and/or encoded_address location_end—may be scaled to match the ratio of number of SBs per block to number of address locations per SB. As a non-limiting example, where the number of SBs per block is double the number of address locations per SB, SB offset—when employed in connection with encoded_address location_start and/or encoded_address location_end—may be halved (e.g., an SB offset of two may be scaled to one and/or a SB offset of six may be scaled to three). As a non-limiting example, where such halving leads to a fractional number, rounding up or down may be employed. As another non-limiting example, where the number of SBs per block is half the number of address locations per SB, SB offset—when employed in connection with encoded_address location_start and/or encoded_address location_end—may be doubled (e.g., an SB offset of two may be scaled to four and/or a SB offset of six may be scaled to twelve).

Further according to the illustrative example, with regard to the above-discussed AP and STA functionality, the noted comparison, performed in connection with encoded_address location_start and/or encoded_address location_end, between address location reference and the SB number indicated by SB offset may instead be comparison between SB reference and the SB number indicated by SB offset.

Additionally according to the illustrative example, it is noted that via the functionality discussed herein in the case where thirteen bit STA identifiers are employed (e.g., 13 bit AIDs), a group start STA identifier (e.g., RAW start AID) may be expressed, with respect to a page, using seven bits (e.g., three bits conveying block, two bits conveying SB, and two bits conveying address location) and/or a group end STA identifier (e.g., RAW end AID) may be expressed, with respect to a page, using seven bits (e.g., three bits conveying block, two bits conveying SB, and two bits conveying address location). As a non-limiting example, such a page may be conveyed via a discussed-herein page index field (e.g., two bits in length) of a segment count IE, such a group start STA identifier may be conveyed via a discussed-herein RAW start AID sub-sub-field (e.g., seven bits in length) of a RPS IE, and/or such group end STA identifier may be conveyed via a discussed-herein RAW end AID sub-sub-field (e.g., seven bits in length) of a RPS IE. Further included in such a RPS IE may be a discussed-herein block encoding sub-sub-field (e.g., two bits in length). Moreover, although to facilitate discussion various functionality is discussed herein at various junctures with respect to hierarchy of four pages, thirty-two blocks per page, eight SBs per block, and eight address locations per SB, such functionality may be analogously applied with respect to other hierarchies.

### Assigned Access Slot Group Indication—Periodic Restricted Access Window Functionality

Further according to the illustrative example, the STA identifiers (e.g. AIDs) corresponding to a hierarchical element (e.g., a block or SB) may be considered to belong to one or more STA identifier groups (e.g., AID groups). As a non-limiting example, such a STA identifier group may be a target wake time (TWT) group. As a further non-limiting example, contemplating hierarchy having four pages, thirty-two blocks per page, eight SBs per block, and eight address locations (e.g., AID address locations) per SB, the eight address locations of such an SB might be split amongst four station identifier groups such that there are a total of 1024 such station identifier groups to a page, bearing in mind that with this non-limiting example there are thirty-two blocks per page, eight SB per block, and four STA identifier (e.g., AID groups) per SB. Identifiers for such 1024 groups may be expressed within ten bits. Correlation between station identifier group identifier and SB may be such that the totality of the STA identifier groups (e.g., 1024 station identifier groups) for the page are numbered 1-last (e.g., 1-1024) starting with the first SB of the first block of the page and ending with the last SB of the last block of the page.

Also according to the illustrative example, Periodic Restricted Access Window (PRAW) group may be expressed in terms of one or more such station identifier groups. Accordingly, a PRAW group sub-field may be expressed as including a page index sub-sub-field (e.g., two bits in length) conveying a page to which a corresponding PRAW group applies and a STA identifier group sub-sub-field (e.g., AID group sub-sub-field) (e.g., ten bits in length) expressing a particular one of the STA identifier groups (e.g., 1024 station identifier groups) of the page to which the PRAW group applies.

Additionally according to the illustrative example, A STA (e.g., a non-TIM STA), knowing its station identifier (e.g., AID) and being aware of the corresponding hierarchy (e.g., one or more pages, one or more blocks per page, one or more SBs per block, and one or more address locations per SB) may determine and/or be aware of the page and SB within which its station identifier sits. As such, the STA, receiving (e.g., from an AP) a PRAW group sub-field may determine from the page index the page to which the corresponding PRAW group applies, and may determine whether or not the specified page matches the page corresponding the STA's identifier. Optionally, the STA may not process the station identifier group sub-sub-field in the case where the STA finds no match of page. The STA may determine, from the station identifier group sub-sub-field, to which of the station identifier groups (e.g., 1024 station identifier groups) of the page specified by the page index sub-sub-field the PRAW group applies. As noted, the STA may be aware of the SB within which its station identifier sits. As such, by being aware of both the SB where its station identifier sits and aware of the discussed station identifier group identifier-SB correlation, the STA may know whether the specified station identifier group indicates the SB of its station identifier. Where the STA finds such to be the case, the STA may consider itself to be a member of the PRAW group to which the PRAW group sub-field applies. Where the STA finds such not to be the case, the STA may consider itself not to be a member of that PRAW group. As a non-limiting example, the STA may be a non-TIM STA which had been operating as a TIM STA and then switched from TIM operation to non-TIM operation. As another non-limiting example, the STA may be a non-TIM STA which had not been previously operating as a TIM STA. Such a non-TIM STA which had not been previously operating as a TIM STA may or may not possess TIM capability.

Still further according to the illustrative example, where station identifiers (e.g., AIDs) are correlated with TWTs such that a STA (e.g., a non-TIM STA) receiving such a station identifier is able to determine therefrom its target wake time (TWT) (e.g., by calculation and/or by consulting a store correlating station identifiers and TWTs), and where the station identifier—TWT correlations are such that all station identifiers corresponding to a hierarchical element (e.g., a page, block, or SB) have corresponding TWTs which fall in a certain span of time—0.39-0.78 ms for a SB as a non-limiting example—the station identifiers which correlate to the TWTs of such a hierarchical element's TWT time span may be considered to constitute a TWT group. Such a TWT group may be employed as a station identifier group.

Moreover, although to facilitate discussion various functionality is discussed herein at various junctures with respect to hierarchy of four pages, thirty-two blocks per page, eight SBs per block, and eight address locations per SB, such functionality may be analogously applied with respect to other hierarchies.

### Hardware and Software

The foregoing discusses computers, such as the discussed AP and STA devices, performing a number of operations. Examples of computers may include smart cards, media devices, personal computers, engineering workstations, PCs PDAs, portable computers, computerized watches, wired and wireless terminals, telephones, communication devices, nodes, servers, network access points, network multicast points, network devices, network stations, set-top boxes, personal video recorders (PVRs), game consoles, portable game devices, portable audio devices, portable media devices, portable video devices, televisions, digital cameras, digital camcorders, Global Positioning System (GPS) receivers, sensors, and wireless personal servers.

Running on such computers are often one or more operating systems. Examples of operating systems include Windows Phone (e.g., Windows Phone 8 or Windows Phone 7), Windows (e.g., Windows 8, Windows 7, or Windows Vista), Windows Server (e.g., Windows Server 2012, Windows server 2008, or Windows Server 2003), Maemo, Symbian OS, WebOS, Linux, OS X, and iOS. Supported by such computers may optionally be one or more of the S60 Platform, the .NET Framework, Java, and Cocoa.

Examples of computers may also include one or more processors operatively connected to one or more memory or storage units, wherein the memory or storage optionally contains data, algorithms, and/or program code, and the processor or processors execute the program code and/or manipulate the program code, data, and/or algorithms.

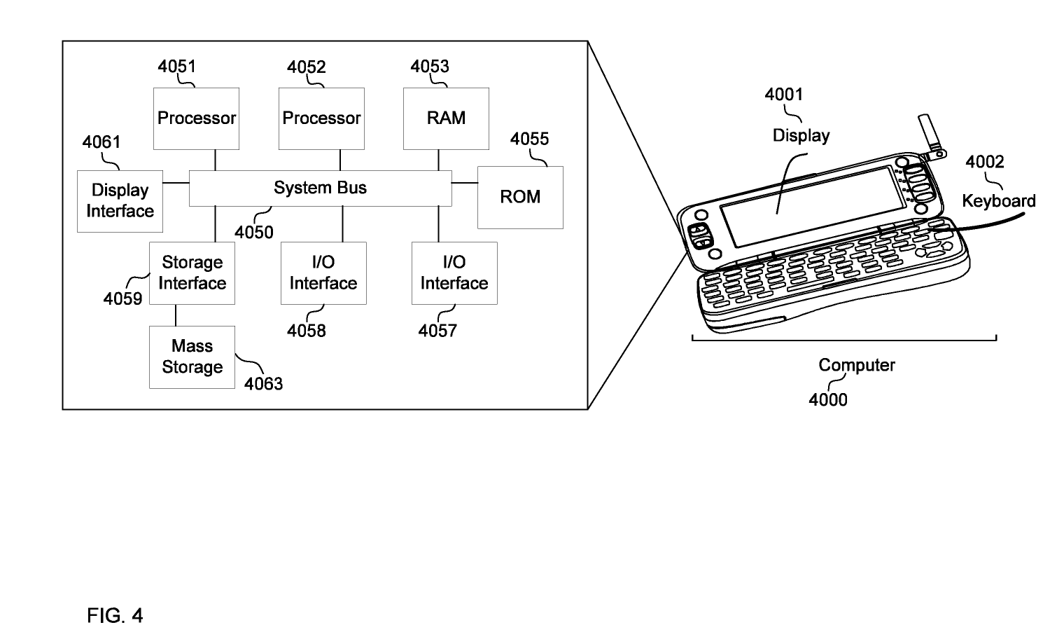

FIG. 4 shows example computer 4000 including system bus 4050 which may operatively connect two processors 4051 and 4052, random access memory 4053, read-only memory 4055, input output (I/O) interfaces 4057 and 4058, storage interface 4059, and display interface 4061. Storage interface 4059 may in turn connect to mass storage 4063. Each of I/O interfaces 4057 and 4058 may an Ethernet, IEEE 1394, IEEE 1394b, IEEE 802.11a, 802.11af, 802.11ah, IEEE 802.11b, IEEE 802.11g, IEEE 802.11i, IEEE 802.11e, IEEE 802.11n, IEEE 802.15a, IEEE 802.16a, IEEE 802.16d, IEEE 802.16e, IEEE 802.16m, IEEE 802.16x, IEEE 802.20, IEEE 802.22, IEEE 802.15.3, ZigBee (e.g., IEEE 802.15.4), Bluetooth (e.g., IEEE 802.15.1), Ultra Wide Band (UWB), Wireless Universal Serial Bus (WUSB), wireless Firewire, terrestrial digital video broadcast (DVB-T), satellite digital video broadcast (DVB-S), Advanced Television Systems Committee (ATSC), Integrated Services Digital Broadcasting (ISDB), Digital Multimedia Broadcast-Terrestrial (DMB-T), MediaFLO (Forward Link Only), Terrestrial Digital Multimedia Broadcasting (T-DMB), Digital Audio Broadcast (DAB), Digital Radio Mondiale (DRM), General Packet Radio Service (GPRS), Universal Mobile Telecommunications Service (UMTS), Long Term Evolution (LTE), Global System for Mobile Communications (GSM), Code Division Multiple Access 2000 (CDMA2000), DVB-H (Digital Video Broadcasting: Handhelds), HDMI (High-Definition Multimedia Interface), Thunderbolt, or IrDA (Infrared Data Association) interface.

Further according to FIG. 4 mass storage 4063 may be a hard drive or flash memory. Each of processors 4051 and 4052 may be an ARM-based processor or an x86-based processor. Computer 4000 as shown in this example may also include a touch screen 4001 and physical keyboard 4002. Optionally a mouse or keypad may alternately or additionally be employed. Moreover, one or more of touch screen 4001 and physical keyboard 4002 may optionally be eliminated.

Additionally according to FIG. 4 computer 4000 may optionally include or be attached to one or more image capture devices. Examples of image capture devices may include ones employing Complementary Metal Oxide Semiconductor (CMOS) hardware and ones employing Charge Coupled Device (CCD) hardware. One or more of the image capture devices may according to one example of an implementation be aimed towards the user. Alternately or additionally, one or more of the image capture devices may be aimed away from the user. The one or more image capture devices may optionally be employed by computer 4000 for video conferencing, still image capture, and/or video capture. Moreover, computer 4000 may optionally include or be attached to one or more card readers, DVD drives, floppy disk drives, hard drives, memory cards, or ROM devices whereby media containing program code—such as program code for performing the discussed operations—is optionally inserted for the purpose of loading the code onto the computer. Further, program code—such as program code for performing the discussed operations—may be optionally loaded the code onto the computer via one or more of I/O interfaces 4057 and 4058, perhaps using one or more networks.

According to an example of an implementation, executed by computers discussed herein may be one or more software modules designed to perform one or more of the discussed operations. Such modules are programmed using one or more languages. Examples of languages include C#, C, C++, Objective C, Java, Perl, and Python. Corresponding program code may be optionally placed on media. Examples of media include DVD, CD-ROM, memory card, and floppy disk.

Any indicated division of operations among particular software modules is for purposes of illustration, and alternate divisions of operation are possible. Accordingly, any operations indicated to be performed by one software module may according to an alternative implementation instead be performed by a plurality of software modules. Similarly, any operations indicated to be performed by a plurality of modules may according to an alternative implementation instead be performed by a single module.

Further, any operations indicated to be performed by a particular computer such as a particular device may according to an alternative implementation instead be performed by a plurality of computers such as by a plurality of devices. Moreover, peer-to-peer, cloud, and/or grid computing techniques may optionally be employed. Additionally, implementations may include remote communication among software modules. Examples of remote communication techniques include Simple Object Access Protocol (SOAP), Java Messaging Service (JMS), Remote Method Invocation (RMI), Remote Procedure Call (RPC), sockets, and pipes.

Optionally, operations discussed herein may be implemented via hardware. Examples of such implementation via hardware include the use of one or more of integrated circuits, specialized hardware, chips, chipsets, Application-Specific Integrated Circuits (ASICs), and Field-Programmable Gate Arrays (FPGAs). As a non-limiting example such hardware may be programmed to perform operations discussed herein using one or more languages such as one or more Hardware Description Languages (HDLs). Examples of HDLs include very-high-speed integrated circuit hardware description language (VHDL) and Verilog.

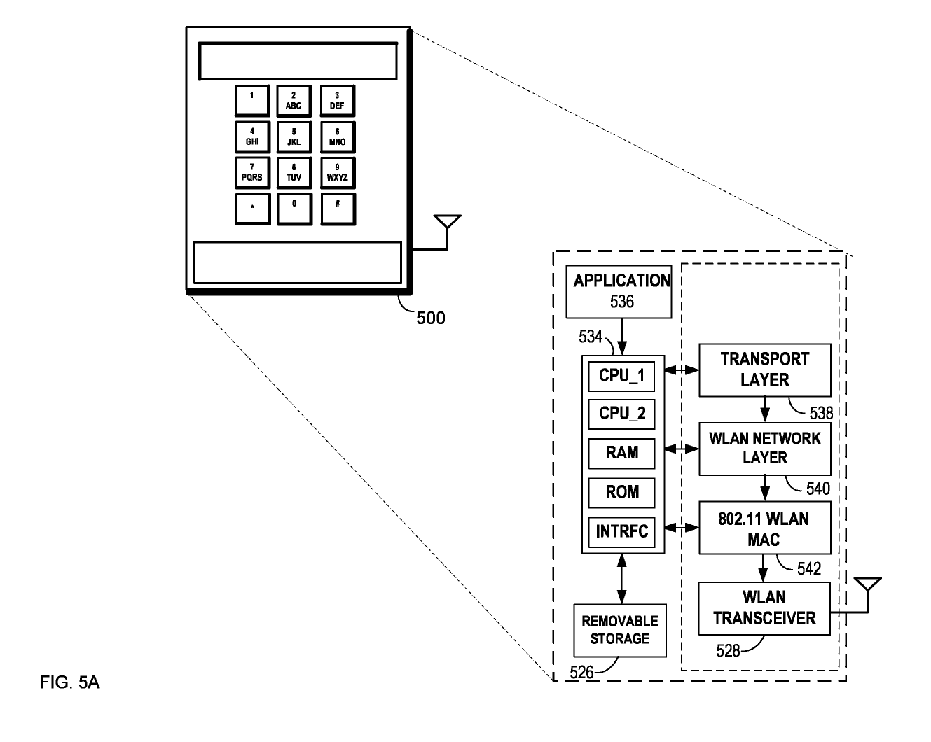

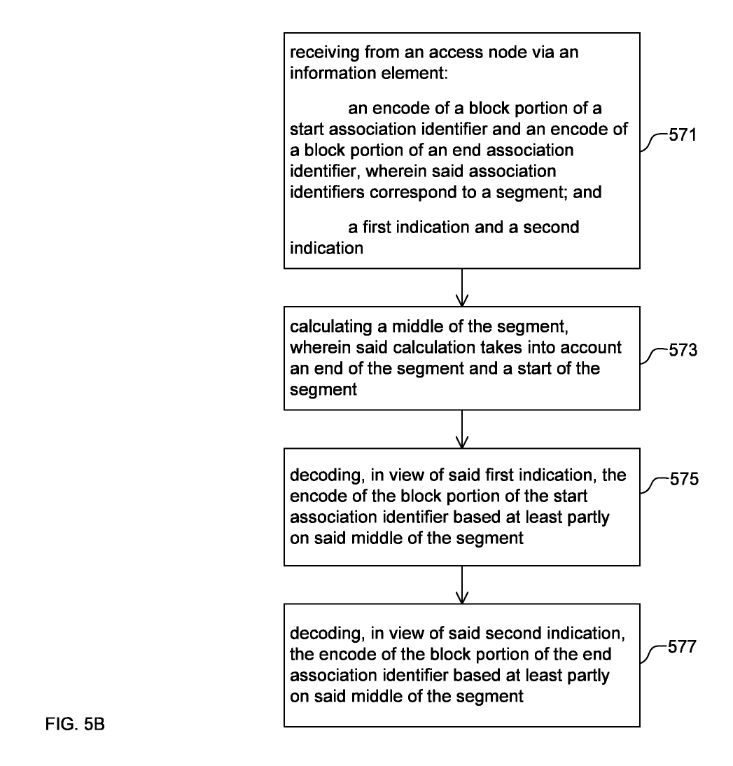

FIG. 5A is an example functional block diagram, illustrating an example AP or STA device 500 according to an example embodiment of the invention. The example device 500 may include a processor 534 that may include dual or multi-core central processing units CPU_{—}1 and CPU_{—}2, a RAM memory, a ROM memory, and an interface for a keypad, display, and other input/output devices. The example device 500 may include a protocol stack, including the transceiver 528 and IEEE 802.11ah MAC 542. The protocol stack may include a network layer 540, a transport layer 538, and an application program 536.

In an example embodiment, the interface circuits in FIG. 5A may interface with one or more radio transceivers, battery and other power sources, key pad, touch screen, display, microphone, speakers, ear pieces, camera or other imaging devices, etc. The RAM and ROM may be optionally removable memory devices 526 such as smart cards, subscriber identity modules (SIMs), wireless identification modules (WIMs), semiconductor memories such as RAM, ROM, PROMS, flash memory devices, etc. The processor protocol stack layers, and/or application program may be according to an example of an implementation embodied as program logic stored in the RAM and/or ROM in the form of sequences of programmed instructions which, when executed in the CPU, carry out the functions of example embodiments. The program logic may according to an example of an implementation be delivered to the writeable RAM, PROMS, flash memory devices, etc. from a computer program product or article of manufacture in the form of computer-usable media such as resident memory devices, smart cards or other removable memory devices. Alternately, they may be embodied as integrated circuit logic in the form of programmed logic arrays or custom designed ASICs. The one or more radios in the device may be separate transceiver circuits or alternately, the one or more radios may be a single RF module capable of handling one or multiple channels in a high speed, time and frequency multiplexed manner in response to the processor. Examples of removable storage media 526 include those based on magnetic, electronic, and/or optical technologies, such as magnetic disks, optical disks, semiconductor memory circuit devices, and micro-SD memory cards (SD refers to the Secure Digital standard) for storing data and/or computer program code as an example computer program product, in accordance with at least one embodiment of the present invention.

In an example embodiment of the invention, the device 500 of FIG. 5A is a device, comprising:

at least one processor 534;

at least one memory, RAM, ROM, and/or removable storage 526 including computer program code represented by the flow diagram of FIG. 5B;

the at least one memory and the computer program code configured to, with the at least one processor, cause the device 500 at least to:

receive from an access node via an information element:
an encode of a block portion of a start association identifier and an encode of a block portion of an end association identifier, wherein said association identifiers correspond to a segment; and
a first indication and a second indication;

calculate a middle of the segment, wherein said calculation takes into account an end of the segment and a start of the segment;

decode, in view of said first indication, the encode of the block portion of the start association identifier based at least partly on said middle of the segment; and

decode, in view of said second indication, the encode of the block portion of the end association identifier based at least partly on said middle of the segment.

FIG. 5B discloses a flow diagram in accordance with at least one example embodiment of the present invention. 571, 573, 575, and 577 of FIG. 5B as a non-limiting example represent computer code instructions stored in the RAM and/or ROM memory of device 500, which when executed by the central processing units (CPU), carry out the functions of an example embodiment of the invention. 571, 573, 575, and 577 are performable in another order than shown and are combinable and/or separable into component operations. As such:

571: receiving from an access node via an information element:
an encode of a block portion of a start association identifier and an encode of a block portion of an end association identifier, wherein said association identifiers correspond to a segment; and
a first indication and a second indication;

573: calculating a middle of the segment, wherein said calculation takes into account an end of the segment and a start of the segment;

575: decoding, in view of said first indication, the encode of the block portion of the start association identifier based at least partly on said middle of the segment; and

577: decoding, in view of said second indication, the encode of the block portion of the end association identifier based at least partly on said middle of the segment.

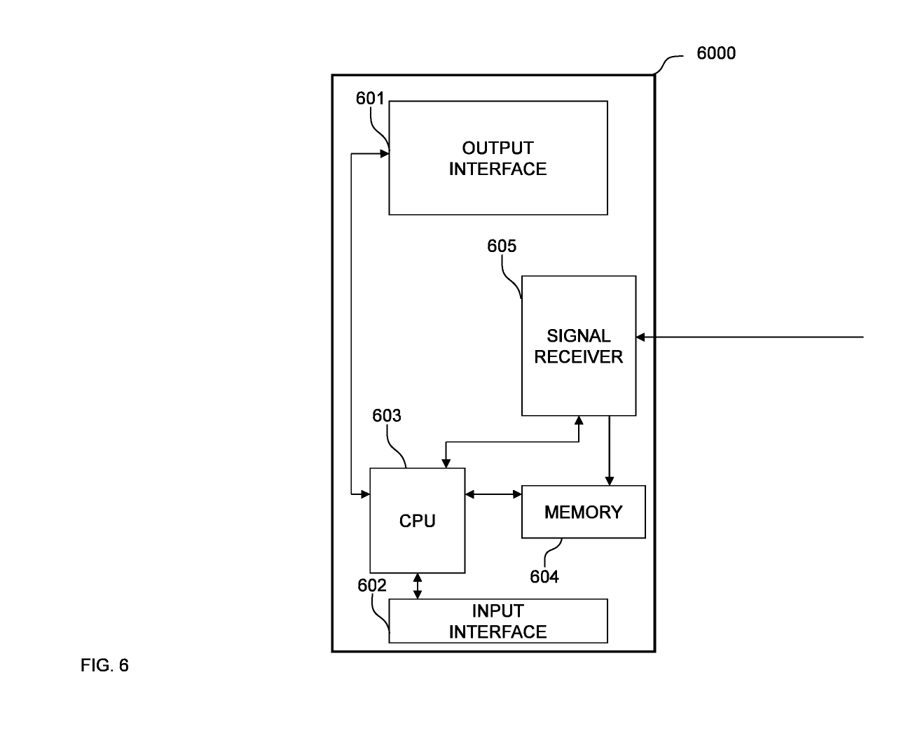

As noted, the foregoing discusses computers such as the discussed AP and STA devices. Shown in FIG. 6 is a block diagram of a further computer according to at least one example embodiment, terminal 6000. Terminal 6000 of FIG. 6 may include a processing unit CPU 603, a signal receiver 605, and a user interface (601, 602). Examples of signal receiver 605 include single-carrier and multi-carrier receivers. Signal receiver 605 and the user interface (601, 602) may be coupled with the processing unit CPU 603. One or more direct memory access (DMA) channels may exist between multi-carrier signal terminal part 605 and memory 604. The user interface (601, 602) may include a display and a keyboard that may enable a user to use the terminal 6000. In addition, the user interface (601, 602) may include a microphone and a speaker for receiving and producing audio signals. The user interface (601, 602) may optionally employ voice recognition.

The processing unit CPU 603 may be a microprocessor, may communicate memory 604, and may optionally communicate with software. The software may be stored in the memory 604. The microprocessor may control, on the basis of the software, the operation of the terminal 6000, such as receiving of a data stream, tolerance of the impulse burst noise in data reception, displaying output in the user interface and the reading of inputs received from the user interface. The hardware may contain circuitry for detecting signal, circuitry for demodulation, circuitry for detecting impulse, circuitry for blanking those samples of the symbol where significant amount of impulse noise is present, circuitry for calculating estimates, and circuitry for performing the corrections of the corrupted data.

Still referring to FIG. 6, middleware or software implementation may be optionally applied. Examples of terminal 6000 may include a hand-held device such as a cellular mobile phone which includes the multi-carrier signal terminal part 605 for receiving multicast transmission streams. Therefore, the terminal 6000 may optionally interact with service providers.

It is noted that although APs and STAs have been discussed at various junctures in connection with IEEE 802.11 so as to facilitate ease of discussion, the APs and STAs discussed herein are not limited to IEEE 802.11 APs and STAs. Non-limiting examples of APs discussed herein may include access points (IEEE 802.11 and/or other than IEEE 802.11), access nodes, base stations, and other devices. Non-limiting examples of STAs discussed herein may include stations (IEEE 802.11 and/or other than IEEE 802.11), mobile terminals, and other devices. APs and STAs discussed herein are, as non-limiting examples, of the networking modalities discussed above in connection with input output (I/O) interfaces 4057 and 4058.

Example embodiments of the invention include an apparatus, comprising:

means for receiving from an access node via an information element:
an encode of a block portion of a start association identifier and an encode of a block portion of an end association identifier, wherein said association identifiers correspond to a segment; and
a first indication and a second indication;

means for calculating a middle of the segment, wherein said calculation takes into account an end of the segment and a start of the segment;

means for decoding, in view of said first indication, the encode of the block portion of the start association identifier based at least partly on said middle of the segment; and

means for decoding, in view of said second indication, the encode of the block portion of the end association identifier based at least partly on said middle of the segment.

### RAMIFICATIONS AND SCOPE

Although the description above contains many specifics, these are merely provided to illustrate the invention and should not be construed as limitations of the invention's scope. For instance, various examples are articulated herein via the discussion of certain aspects. Such aspects are, themselves, merely examples and should not be construed as limitations of the invention's scope. Thus it will be apparent to those skilled in the art that various modifications and variations are applicable to the system and processes of the present invention without departing from the spirit or scope of the invention.

In addition, the embodiments, features, methods, systems, and details of the invention that are described above in the application are combinable separately or in any combination to create or describe new embodiments of the invention.

What is claimed is:

1. A method, comprising:
receiving at a device from an access node via an information element:
an encode of a block portion of a start association identifier and an encode of a block portion of an end association identifier, wherein said association identifiers correspond to a segment; and
a first indication and a second indication;
calculating, at the device, a middle of the segment, wherein said calculation takes into account an end of the segment and a start of the segment;
decoding, at the device in view of said first indication, the encode of the block portion of the start association identifier based at least partly on said middle of the segment; and
decoding, at the device in view of said second indication, the encode of the block portion of the end association identifier based at least partly on said middle of the segment.

2. The method of claim 1, further comprising:
receiving at the device from the access node via the information element an encode of a sub-block portion of the start association identifier and an encode of a sub-block portion of the end association identifier; and
decoding, at the device in view of a reference value and an offset value, the encode of the sub-block portion of the start association identifier and the encode of the sub-block portion of the end association identifier, wherein said offset value provides access node data buffering information with respect to sub-block.

3. The method of claim 1, further comprising:
receiving at the device from the access node via the information element an encode of an address location portion of the start association identifier and an encode of an address location portion of the end association identifier; and
decoding, at the device in view of a reference value and an offset value, the encode of the address location portion of the start association identifier and the encode of the address location portion of the end association identifier, wherein said offset value provides access node data buffering information with respect to sub-block.

4. The method of claim 1, wherein one or more of:
said start association identifier and said end association identifier correspond to a restricted access window; and
said information element is a restricted access window parameter set information element.

5. The method of claim 2, further comprising:
receiving, at the device from the access node via a second information element, said offset value.

6. The method of claim 5, wherein the second information element is a segment count information element.

7. The method of claim 1, wherein said segment is a page segment served by a traffic indication map segment.

8. The method of claim 1, wherein the block portion of the start association identifier and the block portion of the end association identifier are with respect to a page.

9. The method of claim 1, further comprising:
receiving, at the device from the access node, indication of a target wake time group, wherein said target wake time group expresses periodic restricted access window group membership.

10. An apparatus, comprising:
at least one processor; and
at least one memory including computer program code, the at least one memory and the computer program code configured to, with the at least one processor, cause the apparatus at least to perform:
receive at the apparatus from an access node via an information element:
an encode of a block portion of a start association identifier and an encode of a block portion of an end association identifier, wherein said association identifiers correspond to a segment; and
a first indication and a second indication;
calculate, at the apparatus, a middle of the segment, wherein said calculation takes into account an end of the segment and a start of the segment;
decode at the apparatus in view of said first indication, the encode of the block portion of the start association identifier based at least partly on said middle of the segment; and
decode, at the apparatus in view of said second indication, the encode of the block portion of the end association identifier based at least partly on said middle of the segment.

11. The apparatus of claim 10, wherein the at least one memory and the computer program code are further configured to, with the at least one processor, cause the apparatus to:
receive at the apparatus from the access node via the information element an encode of a sub-block portion of the start association identifier and an encode of a sub-block portion of the end association identifier; and
decode, at the apparatus in view of a reference value and an offset value, the encode of the sub-block portion of the start association identifier and the encode of the sub-block portion of the end association identifier, wherein said offset value provides access node data buffering information with respect to sub-block.

12. The apparatus of claim 10, wherein the at least one memory and the computer program code are further configured to, with the at least one processor, cause the apparatus to:
receive at the apparatus from the access node via the information element an encode of an address location portion of the start association identifier and an encode of an address location portion of the end association identifier; and
decode, at the apparatus in view of a reference value and an offset value, the encode of the address location portion of the start association identifier and the encode of the address location portion of the end association identifier, wherein said offset value provides access node data buffering information with respect to sub-block.

13. The apparatus of claim 10, wherein one or more of:
said start association identifier and said end association identifier correspond to a restricted access window; and
said information element is a restricted access window parameter set information element.

14. The apparatus of claim 11, wherein the at least one memory and the computer program code are further configured to, with the at least one processor, cause the apparatus to:
receive, at the apparatus from the access node via a second information element, said offset value.

15. The apparatus of claim 14, wherein the second information element is a segment count information element.

16. The apparatus of claim 10, wherein said segment is a page segment served by a traffic indication map segment.

17. The apparatus of claim 10, wherein the block portion of the start association identifier and the block portion of the end association identifier are with respect to a page.

18. The apparatus of claim 10, wherein the at least one memory and the computer program code are further configured to, with the at least one processor, cause the apparatus to:
receive, at the apparatus from the access node, indication of a target wake time group, wherein said target wake time group expresses periodic restricted access window group membership.

19. A computer program product comprising computer executable program code recorded on a non-transitory computer readable storage medium, the computer executable program code comprising:
code for causing receipt at a device from an access node via an information element of:
an encode of a block portion of a start association identifier and an encode of a block portion of an end association identifier, wherein said association identifiers correspond to a segment; and
a first indication and a second indication;
code for causing calculation, at the device, of a middle of the segment, wherein said calculation takes into account an end of the segment and a start of the segment;
code for causing decode, at the device in view of said first indication, of the encode of the block portion of the start association identifier based at least partly on said middle of the segment; and
code for causing decode, at the device in view of said second indication, of the encode of the block portion of the end association identifier based at least partly on said middle of the segment.

20. An apparatus, comprising:
means for receiving from an access node via an information element:
an encode of a block portion of a start association identifier and an encode of a block portion of an end association identifier, wherein said association identifiers correspond to a segment; and
a first indication and a second indication;
means for calculating a middle of the segment, wherein said calculation takes into account an end of the segment and a start of the segment;
means for decoding, in view of said first indication, the encode of the block portion of the start association identifier based at least partly on said middle of the segment; and
means for decoding, in view of said second indication, the encode of the block portion of the end association identifier based at least partly on said middle of the segment.
